(19) United States
(12) Patent Application Publication
(10) Pub. No.: US 2023/0302547 A1
(43) Pub. Date: Sep. 28, 2023

(54) CHUCK

(71) Applicant: SMW-Autoblok Spannsysteme GmbH, Meckenbeuren (DE)

(72) Inventor: Eckhard Maurer, Oberteuringen (DE)

(21) Appl. No.: 18/124,758

(22) Filed: Mar. 22, 2023

(30) Foreign Application Priority Data
Mar. 22, 2022 (EP) 22 163 508.9

(51) Int. Cl. B23B 31/177

(52) U.S. Cl. CPC B23B 31/16233; B23B 31/16237

(57) ABSTRACT

The invention relates to a chuck (1) via which workpieces (2) are supported on a machine tool in a separate and centered manner for machining by the machine tool, including a chuck body (3) and at least four radially oriented guide grooves (4) that are incorporated into same, including at least four clamping jaws (5, 6, 7, 8) that are situated in each case in pairs in an x or y plane, and separately inserted into one of the guide grooves (4) in a movably supported manner, including a drive element (9) that is mounted in the chuck body (3), and which synchronously feeds the four clamping jaws (5, 6, 7, 8) in the direction of the workpiece (2) to be clamped or is moved away by same, and including a rocker (11) that is provided in each case between the drive element (9) and two adjacent clamping jaws (5, 7 or 6, 8), the rocker having a center of symmetry (12) into which a bolt (13) that is swivelably mounted on the drive element (9) is inserted, the rocker (11) being swivelable about the bolt as a function of the contact of the clamping jaws (5, 6 or 7, 8) with the workpiece (2). According to the invention, movement compensation is to take place between two adjacent clamping jaws (5, 6, 7, 8), via which the various clamping jaws (5, 6, 7, 8) are quickly exchangeable without uninstalling the chuck body (3). This is achieved by providing a wedge rod (31) and/or a drive ring, which in each case are/is drivingly coupled to the drive element (9) and one of the clamping jaws (5, 6, 7, 8), between the drive element (9) and one of the chuck jaws (5, 6, 7, 8).

### REFERENCE TO PENDING PRIOR PATENT APPLICATION

This patent application claims benefit of European Patent Application No. 22 163 508.9, filed Mar. 22, 2022, which patent application is hereby incorporated herein by reference.

### FIELD OF THE INVENTION

The invention relates to a chuck via which workpieces are supported on a machine tool in a separate and centered manner for machining by the machine tool according to the preamble of claim 1.

### BACKGROUND OF THE INVENTION

Such a chuck is previously known from EP 3 623 085 A1, as explained in greater detail below. Reference is also made to EP 3 738 701 A1.

The clamping jaws are typically made up of a base jaw, radially movably mounted in the chuck body and supported there, and a top jaw that is detachably locked to the base jaw via fastening screws, for example. Since multiple threaded holes are provided at the base jaw, these types of top jaws may be mounted at various positions at the base jaw, resulting in a differently sized diameter for the base circle that is formed by the top jaws. The diameter of the base circle is slightly larger than the diameter of the workpiece to be machined, since the feed travel of the top jaws is to be kept as small as possible.

For example, such a clamping device, known by the technical term “chuck,” is known from DE 10 2015 204 502 B4. Provided between the base jaws and a mechanically actuatable drive unit are a rocker, and entraining elements that are each drivingly connected to one of the rockers. In addition, situated in the center of the chuck is a coupling ring on which the four entraining elements are mounted in such a way that play is present between these components in the radial direction. The coupling ring is mounted in the chuck body or the housing of the chuck so as to be rotatable about the clamping axis. A radial feed movement of the base jaw results from rotating the coupling ring, so that a workpiece is held by the four clamping jaws due to the fact that they travel and generate a clamping force in the direction of the workpiece.

Since the clamping of a workpiece using four clamping jaws that are diametrically opposed in pairs represents mechanical overdetermination, the play is to be provided between the coupling ring and the particular entraining element. Namely, when one of the pairs of the clamping jaws impinges earlier on the workpiece to be clamped, their feed movement must be stopped in order to ensure that the clamping jaws extending perpendicularly thereto can cover the distance still present between them and the surface of the workpiece. Only when all of the four clamping jaws rest against the surface of the workpiece is a corresponding clamping force to be generated. The play is thus used as compensation for the clamping jaws when they are moved in the direction of the workpiece. In particular when the workpieces have a rectangular outer contour, so that their side lengths have different dimensions, it is necessary to compensate for these different distances between the pairs of diametrically opposed clamping jaws.

However, due to the necessary play between the coupling ring and the entraining elements, which are mechanically coupled to the base jaws or clamping jaws, significant inaccuracy often results, so that the positioning of the workpiece is incorrect. This in turn results in machining errors at the workpiece itself, since the repeat accuracy of the clamping of a plurality of identical workpieces cannot be guaranteed.

A chuck has become known from EP 3 623 085 A1, in which a rocker is situated in each case between two adjacent clamping jaws, the rocker resulting in compensation movements when two oppositely situated clamping jaws first come into operative contact with the workpiece to be clamped. Namely, the feed movement of the axial piston is not to be stopped until the necessary clamping force is generated by the piston on all of the four clamping jaws. By use of the chuck, the intent is to clamp not only round workpieces, but also rectangular workpieces whose side lengths have different dimensions. Thus, two oppositely situated clamping jaws initially come into operative contact with the workpiece, and the two clamping jaws adjacent thereto continue to be fed by the drive element. The clamping force that holds the workpiece centered between the four clamping jaws is not built up until all four clamping jaws are resting on the surface of the workpiece, and the drive element is further fed.

In these types of clamping devices, it has turned out to be disadvantageous that the base jaw or the respective chuck jaw is fixedly locked to the drive element. This takes place, for example, by use of wedge hooks or other fastening means. As a result, the chuck jaw is not easily released from the drive element, since the chuck body must be completely uninstalled to allow the particular base jaw or chuck jaw to be released from the drive element. However, if workpieces having different dimensions are to be machined in rapid succession, it is disadvantageously absolutely necessary to exchange the respective set of top jaws and adapt the base circle formed by them to the diameter contour of the workpiece to be machined. Accordingly, for different diameters, the top jaws must be continually adapted to the predefined diameter of the workpiece by means of an appropriate turning operation. In addition, for structurally identical workpieces the clamping operation should have repeat accuracy in order to achieve, to the extent possible, identical centering and thus small machining tolerances at the workpiece.

Furthermore, it is disadvantageous that each set of top jaws is usable only for a certain size diameter of workpieces. As soon as the structural shapes of the workpieces differ from one another, time-consuming installation and deinstallation operations are necessary in order to adapt the clamping device or the chuck to the particular intended purpose.

For many years, it has been known to eliminate such disadvantages by using a so-called quick-change system for chucks. For example, such a quick-change system for chucks is described by DE 19 502 363 C1.

However, this chuck has no compensation options, so that it is disadvantageously usable only for workpieces that have a round or square cross section. Workpieces with sides having different dimensions cannot be machined using these chucks, since the chucks have no compensation options for the feed movement of the particular clamping jaws.

### SUMMARY OF THE INVENTION

Therefore, the object of the invention is to refine a chuck of the species stated at the outset, having movement compensation between two adjacent clamping jaws, in such a way that the clamping jaws used are exchangeable, quickly and without uninstalling the chuck body, in order to allow workpieces having different dimensions, possibly with different side lengths, to be clamped and subsequently machined by the machine tool.

This object is achieved according to the invention by the features of the characterizing part of claim 1.

Further advantageous refinements of the invention are claimed in the subclaims.

As the result of providing a wedge rod and/or a drive ring, which in each case are/is drivingly coupled to the drive element and one of the clamping jaws, between the drive element and the respective chuck jaw, the intent is to allow the exchange of the two-part clamping jaws, which are designed as base jaws and top jaws, to be adapted to the outer contour of the workpiece to be machined as quickly and precisely as possible.

It is particularly advantageous when the guide grooves of the particular clamping jaws are open in the region of the circumferential surface of the chuck body, since on the one hand the base jaw may thus protrude, at least partially, from the circumferential region of the chuck body, and may thus initially be set into driving operative connection with the particular wedge rod at a precisely predefined position. As the result of just this measure, the base jaw may be set to the diameter of the workpiece to be machined or to its rectangular outer contour in such a way that the feed travel of the particular top jaw is as small as possible in order to come into operative contact with the surface of the workpiece to be clamped. On the other hand, in addition the base jaw may be pulled out or removed from the guide groove when the driving operative connection between it and the wedge rod is detached or discontinued. In the process, by the movement of the drive element the wedge rod is pulled far away from the base jaw or chuck jaw in the particular guide pocket in such a way that the helical teeth incorporated on the wedge rod are disengaged from the helical teeth incorporated at the surface facing the base jaw and the wedge rod, as the result of which the particular base jaw is released. After the base jaw is detached from the wedge rod, the base jaw may thus be removed from the chuck body and replaced by a base jaw having some other geometry.

By use of a locking bolt or a mechanical locking function, it is possible to orient the particular position of the base jaw relative to a predefined shared base circle around the center of the chuck body and reliably hold it here, in particular until the particular wedge rod is fed in the direction of the base jaw, and the mutually corresponding helical teeth in the wedge rod and in the base jaw are brought into engagement. As soon as the helical teeth intermesh and the wedge rod is further axially moved by the drive element, this results in a radial feed movement of the particular base jaws, and thus of the top jaws mounted thereon, in the direction of the center of the chuck body or in the direction of the workpiece to be clamped.

If the top jaws that are used impinge on the surface of the workpiece to be clamped in a different time interval, initially the movement of the particular top jaw mounted on the surface of the workpiece is stopped, since the rocker provided between the adjacent clamping jaws carries out a compensation movement, as the result of which the chuck jaw, which is still situated at a distance from the workpiece, continues to be fed in the direction of the workpiece. The drive element does not generate the necessary clamping force until all clamping jaws are resting on the surface of the workpiece, since the clamping jaw continues to be axially actuated, and due to the clamping jaws completely resting against the workpiece, the compensation movements of the rockers are fully stopped, or the compensation movement of the rocker can no longer be carried out due to the fixing of the clamping jaws to the workpiece.

### BRIEF DESCRIPTION OF THE DRAWINGS

A chuck according to the invention is illustrated in the drawings and explained in greater detail below. In the drawings:

FIG. 1 shows a chuck having a chuck body in which four mutually perpendicular clamping jaws are radially displaceably mounted, via which a rectangular workpiece is held centered in space, in a top view,

FIG. 2a shows the chuck according to FIG. 1 along the section line IIa-IIa in the clamped state, wherein four guide pockets in which a wedge rod having helical teeth is in each case axially movably mounted, and is in driving operative connection with one of the clamping jaws, are incorporated into the chuck body,

FIG. 2b shows the chuck according to FIG. 2a in the top view, and with a cutaway view via which it is apparent that the guide pockets of the wedge rod are tangentially oriented around a base circle virtually extending around the center of the chuck body,

FIG. 2c shows the chuck according to FIG. 2b immediately before the workpiece is held between the clamping jaws,

FIG. 2d shows the chuck according to FIG. 2c together with the four wedge rods, which are disengaged from the four clamping jaws, and one of the clamping jaws being pulled from its guide groove in order to exchange it,

FIG. 3a shows the chuck according to FIG. 2a along the section line IIIa-IIIa together with a rocker, situated between two adjacent clamping jaws, as movement compensation between these two clamping jaws during the axial feeding,

FIG. 3b shows the chuck according to FIG. 3a in the loaded state, one of the clamping jaws already being in operative contact with the workpiece to be clamped, and the chuck jaw adjacent thereto being spaced apart from the workpiece.

### DETAILED DESCRIPTION OF THE PREFERRED EMBODIMENTS

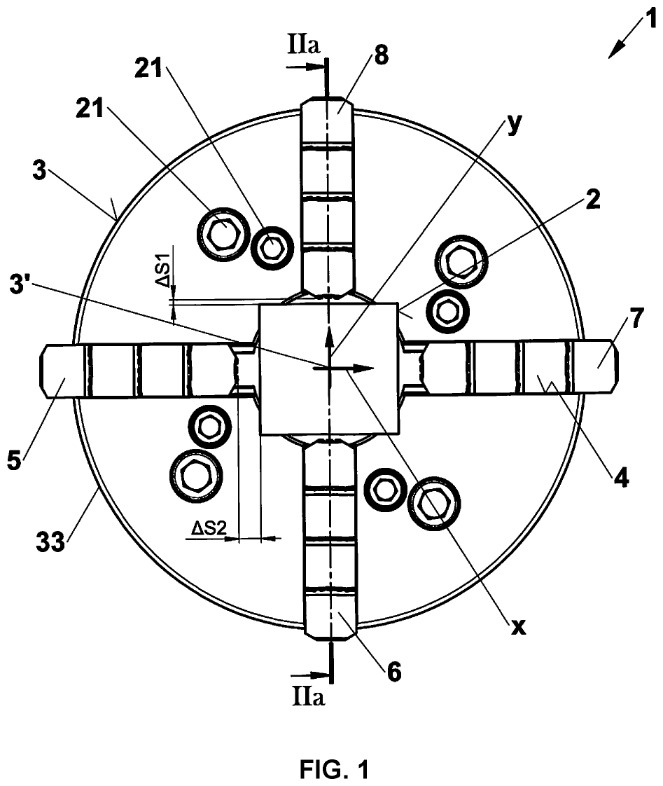

FIG. 1 depicts a chuck 1 that supports a rectangular or round workpiece 2, centered in space, for machining by a machine tool, not illustrated. The chuck 1 is made up of a chuck body 3 on which four clamping jaws 5, 6, 7, and 8 movably mounted. The particular chuck jaw 5, 6, 7, 8 in each case is axially movably mounted in a guide groove 4 incorporated into the chuck body 3.

The clamping jaws 5 and 6 are mounted in an x plane, i.e., diametrically opposite one another, and the clamping jaws 7 and 8 are mounted in a y plane perpendicular thereto. The four clamping jaws 5, 6, 7, and 8 are fed radially in the direction of the center 3′ of the chuck body 3, i.e., in the direction of its longitudinal axis and in the direction of the workpiece 2. However, if the workpiece 2 to be clamped has a trapezoidal or star-shaped outer contour, the clamping jaws 5, 6, 7, 8 may be arranged in any desired position, so that, although one of the x or y planes extends through two of the four clamping jaws 5, 6 or 7, 8, these planes are not oriented perpendicularly to one another.

If the workpiece 2 has different edge lengths or outer contours that are different in some other way (schematically illustrated by ΔS1 and ΔS2), the pairs of clamping jaws 5, 6 or 7, 8 impinge on the surface of the workpiece 2 in a different time period. Namely, if the distance ΔS1 is larger than the distance ΔS2 between the clamping jaws 5, 6 or 7, 8, this results in a different point in time of impingement. However, the four clamping jaws 5, 6, 7, and 8 are moved synchronously by means of a drive element 9, so that this spatial or temporal offset is to be compensated for.

The drive element 9 may be designed as an axially movable piston inside the chuck body 3, or also as a rotating drive ring. The piston 9 moves back and forth linearly, and these movements are transferred from the drive element 9 to the clamping jaws 5, 6, 7, 8 via wedge rods 31, or via the rotation of the drive ring about an axis of symmetry or the center 3′ of the chuck body 3.

For this purpose, helical teeth or wedge hooks may be provided at the drive ring in order to establish a driving operative connection.

In addition, positioning the workpiece 2 in exact alignment with the center 3′ by hand or machine is problematic. Consequently, the center of symmetry of the workpiece 2 often is not in flush alignment with the center 3′ of the chuck body 3. As the result of feeding the clamping jaws 5, 6, 7, and 8, the intent is to eliminate this problem in both the x and the y planes, namely, by compensating for the existing differences in distance by displacing the workpiece 2. This takes place in that the clamping jaws 5, 6 or 7, 8, diametrically opposed in pairs, move the workpiece 2 in the x and/or y plane in order to place the center of symmetry of the workpiece 2 in flush alignment with the center 3′ of the chuck body 3. As soon as the workpiece 2 is clamped between two oppositely situated clamping jaws 5, 6 or 7, 8, it is positioned in the respective x or y plane.

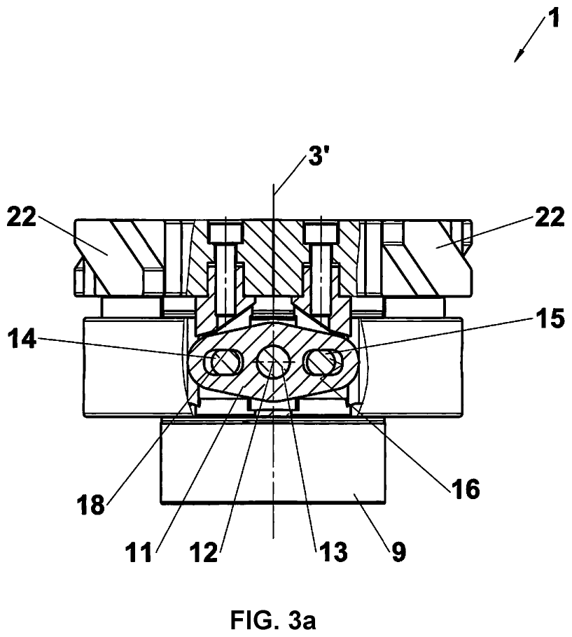

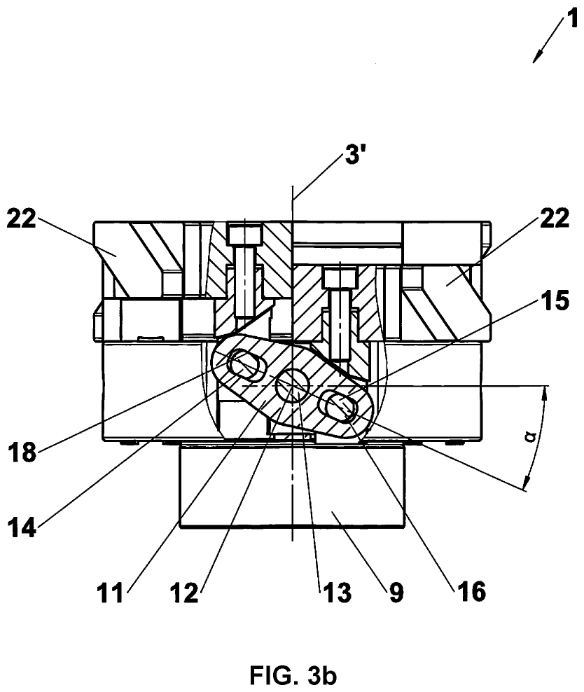

However, if the clamping jaws 5, 6, 7, and 8 are synchronously moved by a drive element 9, the temporal difference of the impingement of the clamping jaws 5, 6, 7, and 8 on the workpiece 2 must be compensated for. This compensation for time or geometry is shown in detail in FIGS. 3a and 3b, or described in EP 3 623 085 A1 and DE 10 2019 100 089 B3, EP 3 028 794 A1, or DE 10 2015 204 502 B4, to which reference is hereby made.

It is apparent from FIG. 3a that four open spaces 23 are incorporated into the drive element 9; the four rockers 11 having a center of symmetry 12 are inserted or arranged in the open spaces. A receiving borehole in which a bolt 13 engages is incorporated into the center of symmetry 12. The bolt 13 is supported on the drive element 9. The rocker 11 is also swivelably mounted on the bolt 13.

Two guide grooves 16, which in the unactuated state of the rocker 11 are oriented perpendicularly with respect to the center 3′, are incorporated into the rocker 11 next to the bolt 13. This means that the rocker 11 in the unactuated state is not deflected, but instead extends perpendicularly with respect to the center 3′.

The actuation of the rocker 11 and the force transmission to the particular chuck jaw 5, 6, 7, or 8 are apparent from FIG. 3b. Namely, a first or second transfer pin 14 or 15 is inserted into the respective guide groove 16. The first transfer pin 14 is associated with the clamping jaws 5 and 6, and the second transfer pin 15 is associated with the clamping jaws 7 and 8, and are drivingly coupled to the clamping jaws in each case.

In addition, at the free end of the transfer pins 14 and 15 associated with the rocker 11, a head 17 is provided in each case which is inserted into the particular guide groove 16 in a linearly displaceable manner. The outer contour of the head 17 is adapted to the inner contour of the guide groove 16 in such a way that the end faces extending in the direction of the longitudinal axis 4 rest against the inner wall of the guide groove 16, and an open space or air gap is present between the end faces of the heads 17 that extend perpendicularly with respect to the longitudinal axis 4. The heads 17 may thus be moved relative to the guide groove 16, perpendicularly with respect to the longitudinal axis 4, even when the rocker 11 is moved around the bolt 13 into one of the two possible deflections. Namely, according to FIG. 3b the chuck jaw 7 impinges on the workpiece 2 first, so that the chuck jaw 5 must be moved further in the direction of the workpiece 2. Accordingly, the rocker 11 compensates for this feed difference between the two pairs of clamping jaws 7 and 8 on the one hand and clamping jaws 5 and 6 on the other hand via the illustrated deflection a. The drive element 9 is pulled away from the workpiece 2 to be clamped, so that the clamping jaws 7 and 8, which are already resting against the workpiece 2, are to be held in position, and the difference ΔS2 minus ΔS1 is to be compensated for by swiveling the rocker 11.

Furthermore, a transfer wedge 22 is situated in the four open spaces 23 in each case as a distance bridge between the rocker 11 and the particular chuck jaw 5, 6, 7, or 8. Through holes 24 through which the particular transfer pin 14, 15 passes or which are penetrated by same are incorporated into the particular transfer wedge 22.

The transfer wedges 22 are used as buffers or as force transmission between the rocker 11 and the clamping jaws 5, 6, 7, or 8, and are displaceably mounted in the chuck body 3 in a linearly movable manner.

As soon as all four clamping jaws 5, 6 or 7, 8 have reached their position in contact with the workpiece 2, the drive element 9 generates the actual clamping force. The further the drive element is driven, the greater the generated clamping force. The rocker 11 and the different arrangement of the transfer pins 14, 15 are not changed thereby, so that they remain in the assumed compensation position.

By use of the chuck 1 according to the invention, workpieces 2 may thus be held centered in space and supported by the machine tool for machining; the workpieces have any given outer contour, since the inner contours of the clamping jaws 5, 6, 7, 8 are adapted to the outer contours of the differently shaped workpieces 2 and may partially encompass them. As explained in greater detail below, this is achieved by positioning the clamping jaws 5, 6, 7, and 8 in relation to a virtual base circle extending around the center 3′. The clamping jaws 5, 6, 7, or 8 may be associated with different base circles.

The above-described movement compensation of the four clamping jaws 5, 6, 7, and 8 has proven to be very successful in practice. However, the geometry of the particular workpiece 2 to be clamped specifies a certain base circle or virtual distance around the center 3′ of the chuck body 3, since the movement distances of the clamping jaws 5, 6, 7, and 8 are limited and therefore must be precisely adapted to the geometry of the workpiece 2. Accordingly, if a certain range of diameters of different workpieces 2 is to be centered on the chuck 1, or the workpieces are asymmetrical, for each of these workpieces 2 an independent set of clamping jaws 5, 6, 7, and 8 must be kept on hand and mounted on the chuck 1. In particular the clamping surfaces of the clamping jaws 5, 6, 7, and 8 facing the workpiece 2 are to be coordinated with one another so that to the extent possible they are positioned on an identical virtual base circle around the center 3′ in the clamped state. Even small tolerance deviations in machining the clamping surface of the clamping jaws 5, 6, 7, and 8 result in shifting of the workpiece 2 relative to the center 3′ of the chuck body 3, so that positioning of structurally identical workpieces 2 with repeat accuracy is ruled out.

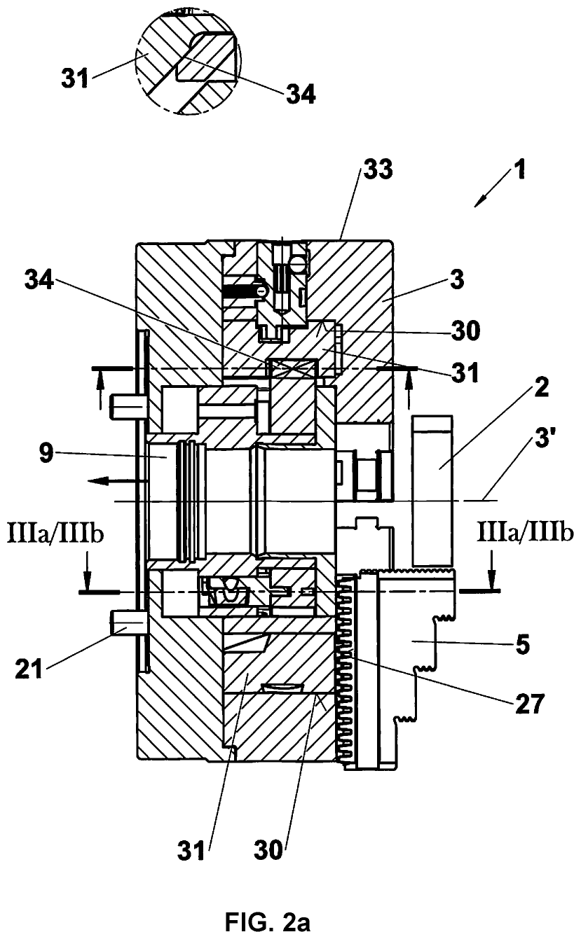

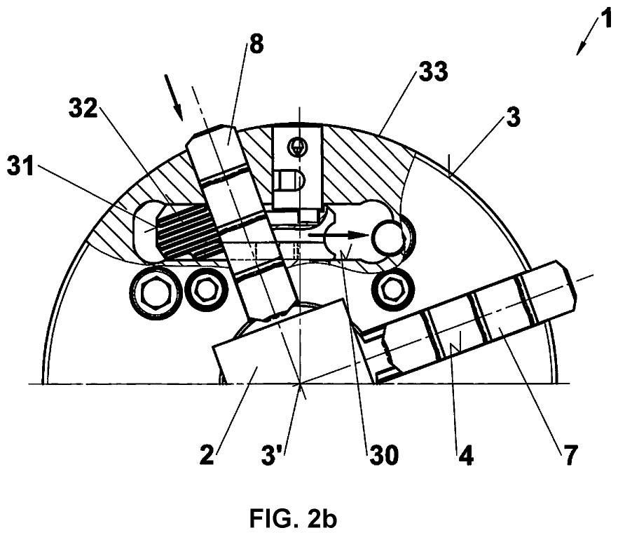

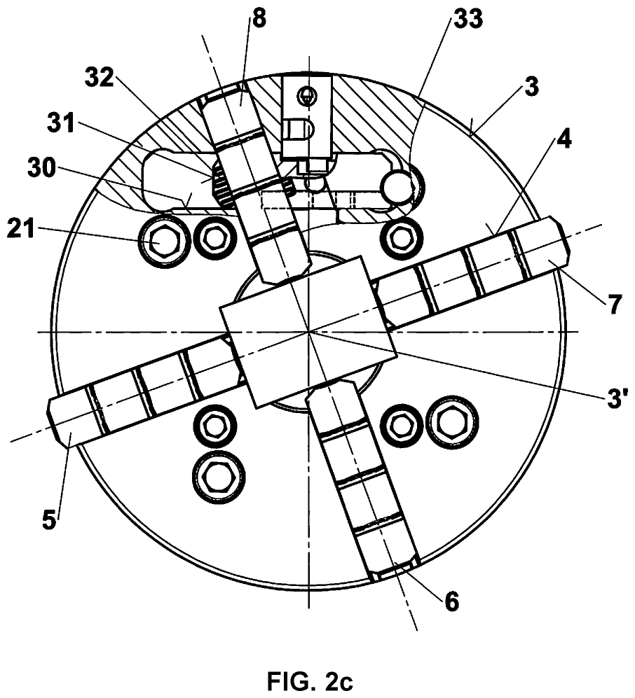

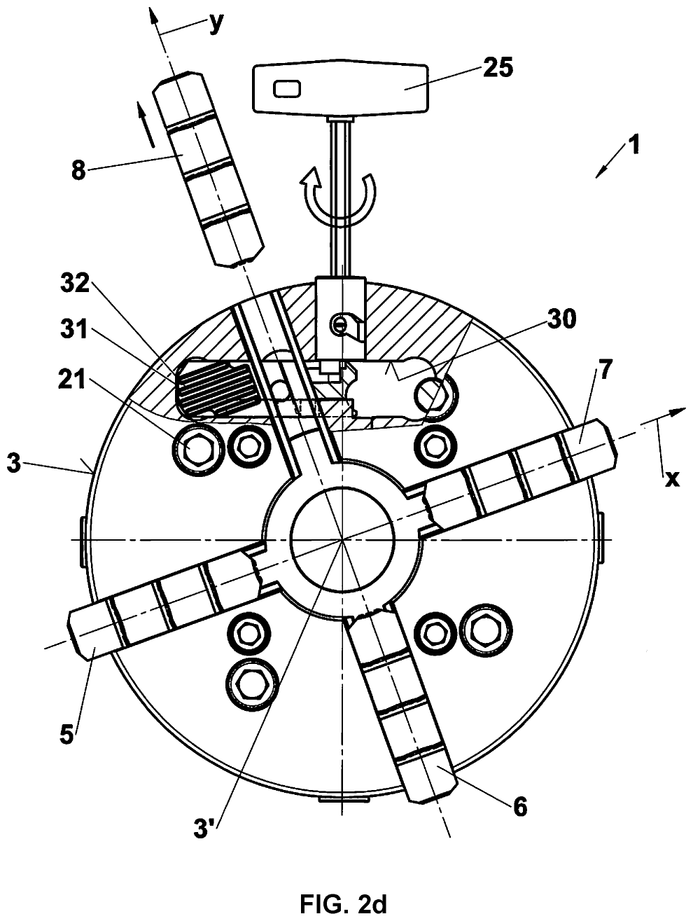

Accordingly, to be able to clamp the largest possible range of workpieces 2, having different dimensions with centering and repeat accuracy, on the chuck 1 using a set of clamping jaws 5, 6, 7, and 8, the type of drive or the driving coupling between the clamping jaws 5, 6, 7, and 8 as well as the drive element 9 are improved. A wedge rod 31 is now provided between the drive element 9 and the particular chuck jaw 5, 6, 7, and 8. Each of the wedge rods 31 is initially in a driving operative connection with the drive element 9, since the particular wedge rod 31 is drivingly coupled to the wedge rod 31 by use of a wedge hook 34. This is shown in particular in the enlarged cutaway view in FIG. 2a.

Furthermore, four guide pockets 30 are incorporated into the chuck body 3, each extending tangentially around the center 3′ of a shared virtual base circle. One of the wedge rods 31 is axially movably situated in each of the guide pockets 30. As a result, each of the wedge rods 31 moves in the particular guide pocket 30 as soon as the drive element 9 is axially moved. The movement speeds and the distances covered by the wedge rod 31 are identical to one another; the wedge rods thus run synchronously with respect to one another.

According to FIGS. 2a through 2d, each of the wedge rods 31 is provided with helical teeth 31 that act as a force transmission means. The course of the helical teeth 31 relates to the longitudinal axis of the particular wedge rod 31.

Each of the clamping jaws 5, 6, 7, and 8 is typically made up of a base jaw and a top jaw that is screwable thereto, so that the positions of the top jaws are variably settable relative to the base jaw in a certain installation area. Each of the base jaws or each of the clamping jaws 5, 6, 7, and 8 has helical teeth 10 situated inside the chuck body 3. The inclinations of the two helical teeth 10 and 32 are identical, so that the helical teeth 32 of the wedge rod 31 may be brought into engagement with each of the helical teeth of the clamping jaws 5, 6, 7, and 8. A form-fit operative connection is thus established between the particular wedge rod 31 and the chuck jaw 5, 6, 7, and 8 as soon as the helical teeth 10 and 32 are engaged with one another.

This means that the movements of the wedge rods 31, which are tangentially oriented in the guide pocket 30, result in a radial feed movement of the clamping jaws 5, 6, 7, and 8 due to the alignment of the guide grooves 4 in which the clamping jaws 5, 6, 7, and 8 are axially movably mounted, and result in the selected inclinations of the helical teeth 10 and 32.

It is apparent in particular from FIG. 2d that the form-fit operative connection between the helical teeth 10 and 32, which is necessary during the clamping operation, must be detached when the clamping jaws 5, 6, 7, and 8 are exchanged. This takes place by use of a tool 25 which moves each of the wedge rods 31 in the guide pocket 30 far enough away from the clamping jaws 5, 6, 7, and 8 that the helical teeth 10 and 32 are disengaged. Thus, as soon as there is no longer a form-fit or force-fit operative connection between the helical teeth 10 of the particular chuck jaw 5, 6, 7, and 8 and the helical teeth 32 of the wedge rod 31, the particular chuck jaw 5, 6, 7, and 8 may be pulled out of the guide groove 4, since the end face of the guide groove 4 associated with the circumferential surface 33 of the chuck body 3 has an open design.

Due to the movement options of the wedge rod 31 inside the guide pockets 30, the guide pockets may be precisely positioned in such a way that an arrangement of the clamping jaws 5, 6, 7, and 8 is settable with repeat accuracy, and at the same time, the particular diameter of the workpiece 2 to be machined is taken into account. This take place by initially moving the clamping jaws 5, 6, 7, and 8 in the particular guide groove 4 at a shared or individual base circle and holding them there, since the particular wedge rod 31 is positioned far enough away from the clamping jaws 5, 6, 7, and 8 that they are displaceable in the guide grooves 4 in a freely movable manner. By use of suitable aids, for example in the form of spring-loaded pins, templates, workpieces 2 to be clamped that are already prepositioned, or the like, it is thus possible to set the shared position of the clamping jaws 5, 6, 7, and 8 that corresponds to a virtual base circle around the center 3′. After this desired position of the clamping jaws 5, 6, 7, and 8 is reached, the wedge rods are fed in the direction of the clamping jaws 5, 6, 7, and 8 by means of the tool 25 in the guide pocket 30, so that the helical teeth 32 of the wedge rod 31 come into engagement with the helical teeth 10 of the clamping jaws 5, 6, 7, and 8, and the necessary form-fit operative connection between them is established. The drive element 9 may subsequently synchronously actuate the wedge rod 31, as the result of which the radial feeding of the clamping jaws 5, 6, 7, and 8 takes place.

What is claimed is:

1. A chuck (1) via which workpieces (2) are supported on a machine tool in a separate and centered manner for machining by the machine tool,
including a chuck body (3) and at least four radially oriented guide grooves (4) that are incorporated into same,
including at least four clamping jaws (5, 6, 7, 8) that are situated in each case in pairs in an x or y plane, and separately inserted into one of the guide grooves (4) in a movably supported manner,
including a drive element (9) that is mounted in the chuck body (3), and which synchronously feeds the four clamping jaws (5, 6, 7, 8) in the direction of the workpiece (2) to be clamped or is moved away by same,
including a rocker (11) that is provided in each case between the drive element (9) and two adjacent clamping jaws (5, 7 or 6, 8), the rocker having a center of symmetry (12) into which a bolt (13) that is swivelably mounted on the drive element (9) is inserted, the rocker (11) being swivelable about the bolt as a function of the contact of the clamping jaws (5, 6 or 7, 8) with the workpiece (2),
characterized in that
a wedge rod (31) is provided between the drive element (9) and the particular chuck jaw (5, 6, 7, 8), the wedge rod in each case being drivingly coupled to the drive element (9) and to one of the clamping jaws (5, 6, 7, 8), a force transmission means (32) being associated with each of the wedge rods (31), the particular force transmission means (32) of the wedge rods (31) being designed as helical teeth, and helical teeth (33) that correspond to the particular chuck jaw (5, 6, 7, 8) being incorporated at the surface of the particular chuck jaw facing the wedge rod (31), the helical teeth being in form-fit engagement with one another during the movement process and during the clamped state of the clamping jaws (5, 6, 7, 8), and the guide grooves (4) of the clamping jaws (5, 6, 7, 8) being open in the region of the outer circumferential surface of the chuck body (3), and the particular chuck jaw (5, 6, 7, 8) being disengageable from the wedge rod by pushing the wedge rod away from the chuck jaw (5, 6, 7, 8) in such a way that the particular chuck jaw is released and is removable from or insertable into the particular guide groove (4).

2. The chuck according to claim 1,
characterized in that
the guide pocket (30) of the particular wedge rod (31) is tangentially situated with respect to the center (3′) of the chuck body (3).

3. The chuck according to claim 1,
characterized in that
the particular wedge rod (31) is connected to the drive element (9) in a positionally oriented manner by use of a wedge hook (34), helical teeth, or a fastening pin in such a way that the movement of the drive element (9) specifies or restricts the movement limits of the particular wedge rod (31).

4. The chuck according to claim 1,
characterized in that
the particular chuck jaw (5, 6, 7, 8) in the particular guide groove (4) is fixed, with regard to a shared base circle, about the center (3′) of the chuck body (3) by means of a locking pin, while the helical teeth (32) of the wedge rod (31) are disengaged from the helical teeth (10) of the particular chuck jaw (5, 6, 7, 8).

5. The chuck according to claim 1,
characterized in that
a transfer pin (14, 15) that is drivingly coupled to the rocker (11) is situated next to the bolt (13), and the particular chuck jaw (5, 6, 7, or 8) is mounted and supported at the end of the transfer pin opposite from the rocker (11),
a transfer wedge (22) as a distance bridge is situated between the rocker (11) and the particular chuck jaw (5, 6, 7, or 8), and
a through hole (24) through which the particular transfer pin (14, 15) passes or which is penetrated by same is incorporated into the transfer wedge (22).

6. The chuck according to claim 1,
characterized in that
the wedge rod (31) is axially movably supported in a guide pocket (30) that is incorporated into the chuck body (3), and
the particular wedge rod (31) includes a force transmission means (32) that is detachably connected to the particular chuck jaw (5, 6, 7, 8).
